(19) United States
(12) Patent Application Publication
(10) Pub. No.: US 2002/0113025 A1
(43) Pub. Date: Aug. 22, 2002

(54) Filtration system for storm water catch basins

(76) Inventors: Patrick W. Gauldin, Monroe, NC (US); Christopher L. Gauldin, Indian Trail, NC (US)

Correspondence Address: Adams, Schwartz & Evans, P.A., 2180 Two First Union Center, Charlotte, NC, 28282, US

(21) Appl. No.: 10/015,067

(22) Filed: Dec. 11, 2001

Related U.S. Application Data
(60) Provisional application No. 60/254,664, filed on Dec. 11, 2000.

(51) Int. Cl. B01D 37/00

(52) U.S. Cl. 210/767; 210/163; 210/162; 210/164; 404/4

(57) ABSTRACT

A silt filtration system is adapted for placement at an inlet of a storm water catch basin. The filtration system cooperates with a grate located adjacent a street curb at a mouth of the inlet to separate silt and debris entrained in storm water entering the catch basin. The filtration system includes a frame adapted for residing between the grate and the mouth of the inlet. The frame has elongated front, rear, and opposing side frame members. A filtration medium is supported within the frame, and is arranged to filter storm water entering the catch basin through the grate. A backsplash is attached to the rear frame member. The backsplash extends outwardly from the grate and upwardly into an open curb space between the grate and the curb, such that storm water splashing over the grate and into the curb space is deflected by the backsplash into the filtration medium within the frame.

This application claims priority to provisional application Serial No. 60/254,664 filed on Dec. 11, 2000. This application relates to a silt filtration system for below-grade catch basins. The invention is especially applicable for use at curbside storm drains covered by heavy iron grates. The invention cooperates with the existing grate to capture silt and debris entrained in storm water entering the catch basin.

### TECHNICAL FIELD AND BACKGROUND OF INVENTION

Silt filtration systems for storm drain catch basins are well known and widely used. According to one prior art system described in U.S. Pat. No. 5,372,714, a filter bag is located below grade level in the catch basin, and is held in place by the rectangular iron grate resting on four looped flaps formed at the open top of the filter bag. The looped flaps extend above grade level and away from the grate. To ensure proper and effective use of the filter bag, all four flaps must be sandwiched between the four sides of the grate and the mouth of the inlet. While this system is generally effective for storm drains located in parking lots and other open areas, it is less applicable for curbside street drains which typically have an open drain space between the grate and the curb. For these drains, the filtration system must include support means for carrying the side of the filter bag adjacent the open curb space. In addition, the system must account for any storm water splashing over the grate and entering the catch basin through the curb space.

The present invention addresses this need in the industry for a silt filtration system especially adapted for use in curbside storm drains. The invention supports the filter bag along all four sides, and provides a backsplash which extends above the grate and into the open curb space to deflect any storm water splashing over the grate into the filter bag. The backsplash is integrally formed with the system to prevent its unauthorized or inadvertent removal. When full, the filter bag can be conveniently removed from the mouth of the catch basin for emptying.

### SUMMARY OF INVENTION

Therefore, it is an object of the invention to provide a silt filtration system which is especially applicable for use in curbside storm drains.

It is another object of the invention to provide a silt filtration system which effectively captures silt and debris entrained in storm water entering a catch basin.

It is another object of the invention to provide a silt filtration system which deflects any storm water splashing over the grate into the filtration system.

It is another object of the invention to provide a silt filtration system which includes a filter bag which can be conveniently removed from the catch basin for emptying.

It is another object of the invention to provide a silt filtration system which includes a filter bag which can be removed together with the supporting frame to prevent inadvertent dumping of the filter bag into the catch basin.

It is another object of the invention to provide a method of filtering silt and debris entrained in storm water entering a below-grade catch basin.

These and other objects of the present invention are achieved in the preferred embodiments disclosed below by providing a silt filtration system adapted for placement at an inlet of a storm water catch basin. The filtration system cooperates with a grate located adjacent a street curb at a mouth of the inlet to separate silt and debris entrained in storm water entering the catch basin. The filtration system includes a frame adapted for residing between the grate and the mouth of the inlet. The frame has elongated front, rear, and opposing side frame members. A filtration medium is supported within the frame, and is arranged to filter storm water entering the catch basin through the grate. A backsplash is attached to the rear frame member. The backsplash extends outwardly from the grate and upwardly into an open curb space between the grate and the curb, such that storm water splashing over the grate and into the curb space is deflected by the backsplash into the filtration medium within the frame.

According to another preferred embodiment of the invention, the filtration medium is a silt bag.

According to another preferred embodiment of the invention, cooperating front and rear support rods extend between opposing side frame members for suspending the silt bag from the frame.

According to another preferred embodiment of the invention, the silt bag has open-ended front and rear sleeves formed along its top marginal portion for receiving respective front and rear support rods.

According to another preferred embodiment of the invention, the frame includes cooperating pairs of generally V-shaped carriers adapted for holding opposing ends of respective front and rear support rods.

According to another preferred embodiment of the invention, first and second side support rods extend between the front and rear frame members and cooperate with the front and rear support rods to suspend the silt bag from the frame.

According to another preferred embodiment of the invention, the frame members are angle irons.

According to another preferred embodiment of the invention, at least one lift eye is attached to the frame and is adapted for receiving a lift hook used to remove the frame and filtration medium from the inlet of the catch basin.

According to another preferred embodiment of the invention, the backsplash includes a lower splash panel attached to the rear frame member. The lower splash panel extends outwardly from the rear frame member at an angle greater than 90 degrees and less than 160 degrees relative to a notional plane extending through the front, rear, and side frame members.

According to another preferred embodiment of the invention, the backsplash further includes an upper splash panel formed at an angle greater than 90 degrees and less than 160 degrees to the lower splash panel.

According to another preferred embodiment of the invention, opposing side splash panels are attached to the backsplash and respective side frame members to further deflect storm water into the filtration medium within the frame.

In another embodiment, the invention is a silt filtration system adapted for placement at an inlet of a storm water catch basin. The system cooperates with a grate located adjacent a street curb at a mouth of the inlet to separate silt and debris entrained in storm water entering the catch basin The filtration system includes a frame adapted for residing between the grate and the mouth of the inlet, and having elongated front, rear, and opposing side frame members. A silt bag is supported within the frame and arranged to filter storm water entering the catch basin through the grate. A backsplash is attached to the rear frame member. The backsplash extends outwardly from the grate and upwardly into an open curb space between the grate and the curb, such that storm water splashing over the grate and into the curb space is deflected by the backsplash into the filtration medium within the frame. First and second lift eyes are attached to respective side frame members. The lift eyes are adapted for receiving lift hooks used to remove the frame and silt bag from the inlet of the catch basin.

In yet another embodiment, the invention is a method of filtering silt and debris entrained in storm water entering a below-grade catch basin through a grate located at an inlet of the catch basin adjacent a street curb. The method includes the step of positioning a filtration medium within a frame residing between the grate and a mouth of the inlet. The frame has elongated front, rear, and opposing side frame members. A backsplash is attached to the rear frame member. The backsplash extends outwardly from the grate and upwardly into an open curb space between the grate and the curb, such that storm water splashing over the grate and into the curb space is deflected by the backsplash into the filtration medium within the frame.

According to another preferred embodiment of the invention, the method includes removing the frame and filtration medium from the mouth of the catch basin to empty silt and debris captured by the filtration medium.

According to another preferred embodiment of the invention, the step of removing the frame and filtration medium includes securing lift hooks to respective lift eyes attached to the frame.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an environmental cross-sectional view of a silt filtration system according to one preferred embodiment of the invention, and showing the filtration system in place at a curbside inlet of the catch basin;

FIG. 2 is an exploded perspective view of the silt filtration system;

FIG. 3 is an enlarged, fragmentary cross-sectional view of the frame and backsplash with the support rods of the silt bag shown in phantom;

FIG. 4 is a perspective view of the frame showing the arrangement of the support rods used for carrying the silt bag; and

FIG. 5 is an environmental perspective view showing the silt bag and frame being removed simultaneously from the mouth of the catch basin.

### DESCRIPTION OF THE PREFERRED EMBODIMENT AND BEST MODE

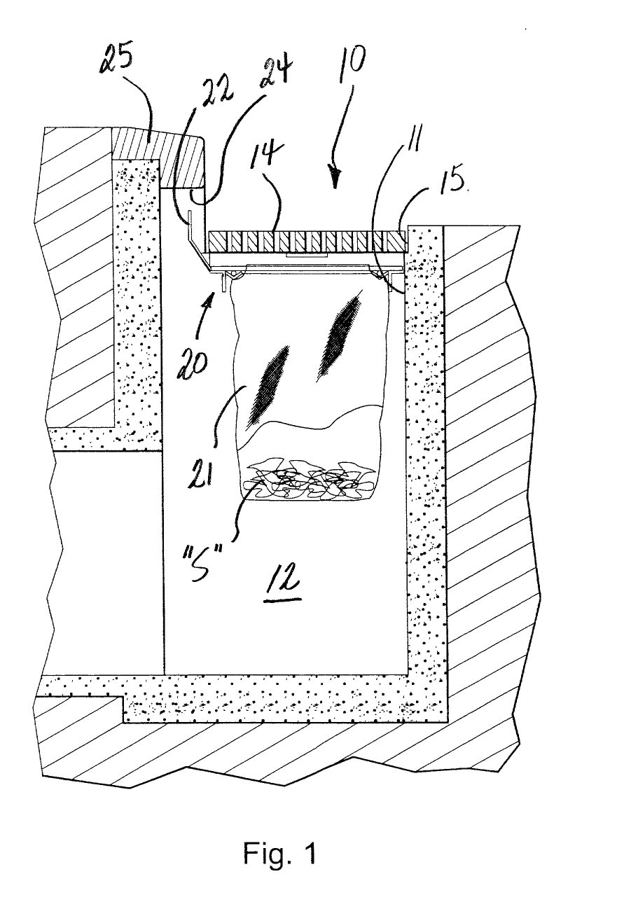

Referring now specifically to the drawings, a silt filtration system according to the present invention is illustrated in FIG. 1, and shown generally at reference numeral 10. The filtration system 10 is located at the inlet 11 of a storm water catch basin 12, and cooperates with a heavy iron grate 14 placed at the mouth 15 of the inlet 11 to capture silt and debris “S” entrained in storm water entering the catch basin 12. The filtration system 10 includes a frame 20 supported at the mouth 15 of the inlet 11 below the grate 14, a silt bag 21 suspended from the frame 20 within the catch basin 12, and a backsplash 22 attached to the rear of the frame 20. The backsplash 22 extends outwardly from the grate 14 and upwardly into an open curb space 24 between the grate 14 and the curb 25. Any storm water splashing over the grate 14 and into the curb space 24 is deflected by the backsplash 22 into the silt bag 21. The silt bag 21 is sufficiently porous to allow free passage of water while filtering out silt and other solids.

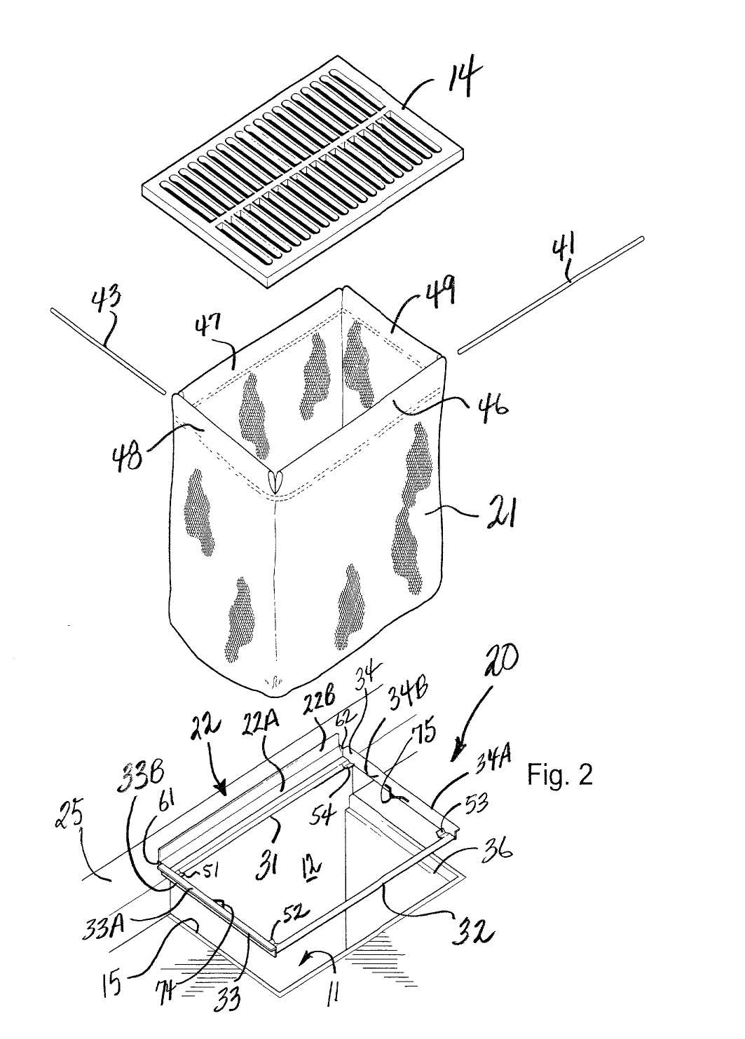

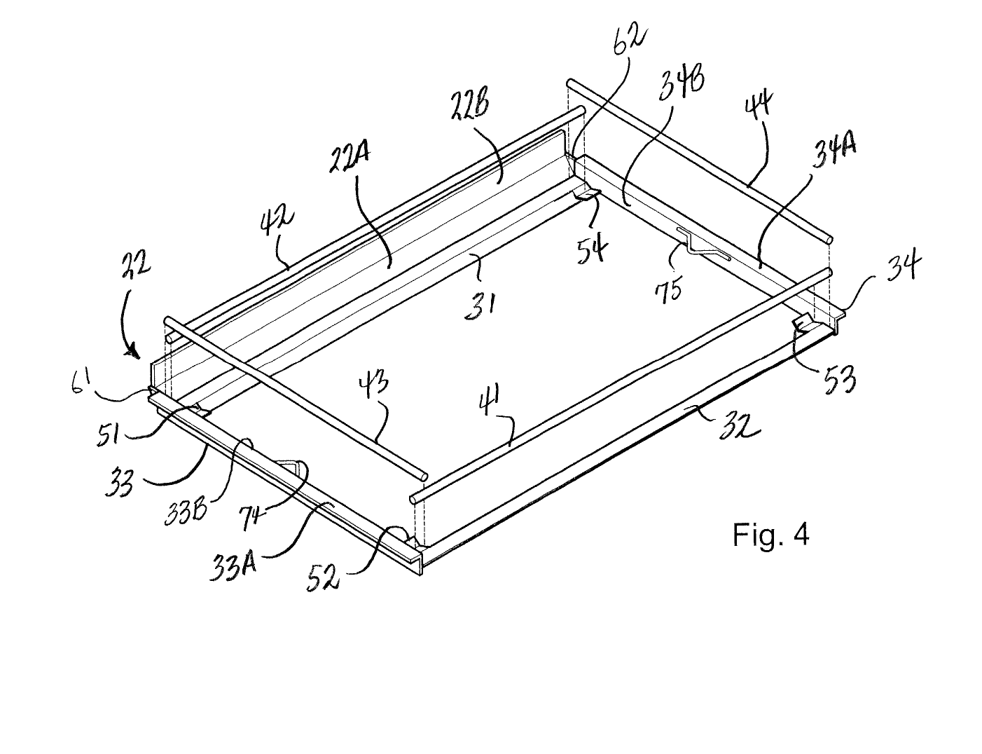

The frame 20 of the filtration system is best shown in FIGS. 2 and 4. The frame 20 is constructed of front and rear frame members 31 and 32 and opposing side frame members 33 and 34 welded together at respective ends and shaped to fit within the mouth 15 of the catch basin 12. According to one embodiment, the frame members 31-34 are angle irons having respective, integrally-formed, horizontal and vertical flanges. The horizontal flanges 33A and 34A of the side frame members 33 and 34 face outwardly and rest on opposing shoulders 36 (only one shown) formed at the mouth 15 of the inlet 11 to support the frame 20 above the catch basin 12. The front and rear frame members 31 and 32 are welded to the side frame members 33 and 34 below the horizontal flanges 33A and 34A.

The silt bag 21 is suspended from the frame 20 using four iron support rods 41, 42, 43, and 44. The support rods 41-44 extend through respective open-ended sleeves 46, 47, 48, and 49, shown in FIG. 2, formed along the top margin of the silt bag 21. The front and rear rods 41 and 42 are supported at respective ends on V-shaped carriers 51, 52, 53, and 54 welded to the frame 20. The side rods 43 and 44 are carried on the front and rear rods 41 and 42. The V-shaped carriers 51-54 are located below the horizontal flanges 33A, 34A of the side frame members 33, 34 a distance sufficient to accommodate the bag support rods 41-44, such that the grate 14 rests flat on the frame 20 when positioned at the mouth 15 of the catch basin 12. Preferably, stops (not shown) are welded to the front and rear frame members 31 and 32 to hold the side rods 43 and 44 in position adjacent the side frame members 33 and 34. The support rods 41-44 cooperate to uniformly distribute the load of the silt bag 21 along all four sides. According to one embodiment, the silt bag 21 is made of a woven geotextile capable of supporting a weight of as much as 4000 lbs.

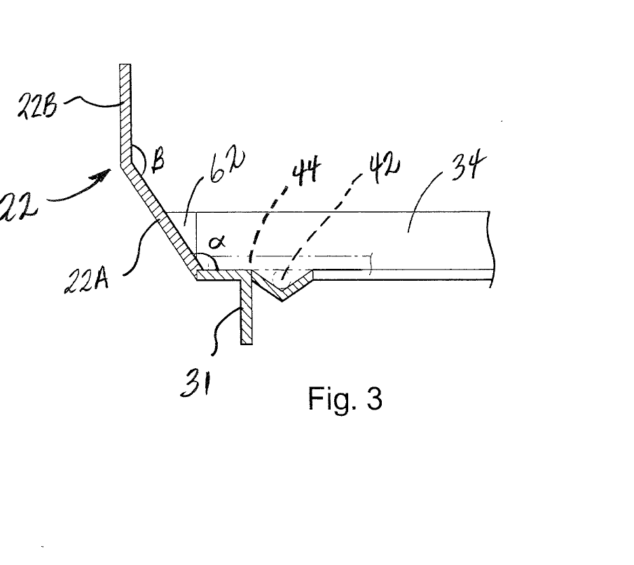

Referring to FIGS. 1, 3, and 4, the backsplash 22 of the filtration system 10 extends along the entire length of the frame 20, and is attached directly to the rear frame member 31 by welding or other suitable means. The backsplash 22 is constructed of integrally-formed upper and lower splash panels 22A and 22B. As shown in FIG. 3, the lower splash panel 22A extends outwardly from the rear frame member 31 at an angle “α” of approximately 120 degrees relative to a notional plane extending through the front, rear, and side frame members 31-34. The upper splash panel 22B is disposed at an angle “β” approximately 140 degrees to the lower splash panel 22A. The upper splash panel 22B extends vertically above the grate 14, as shown in FIG. 1, to deflect into the silt bag 21 any storm water splashing over the grate 14 and into the open curb space 24 between the grate 14 and the curb 25. Opposing side splash panels 61 and 62, shown in FIG. 4, are preferably attached to the backsplash 22 and respective side frame members 33 and 34 to seal the space between the grate 14 and the lower splash panel 22A.

The filtration system 10 is installed in the catch basin 12 by first removing the curbside grate 14 located at the mouth 15 of the inlet 11. The frame 20 is then placed on the existing shoulders 36 used for supporting the grate 14. The silt bag 21 is then located inside the frame 20 such that respective opposing ends of the front and rear support rods 41 and 42 rest on the V-shaped carriers 51-54. The side support rods 43 and 44 rest on the front and rear rods 41 and 42, as previously described, and are contained by the stops to fully open the silt bag 21 between the frame members 31-34. Once properly installed, the iron grate 14 is replaced over the frame 20.

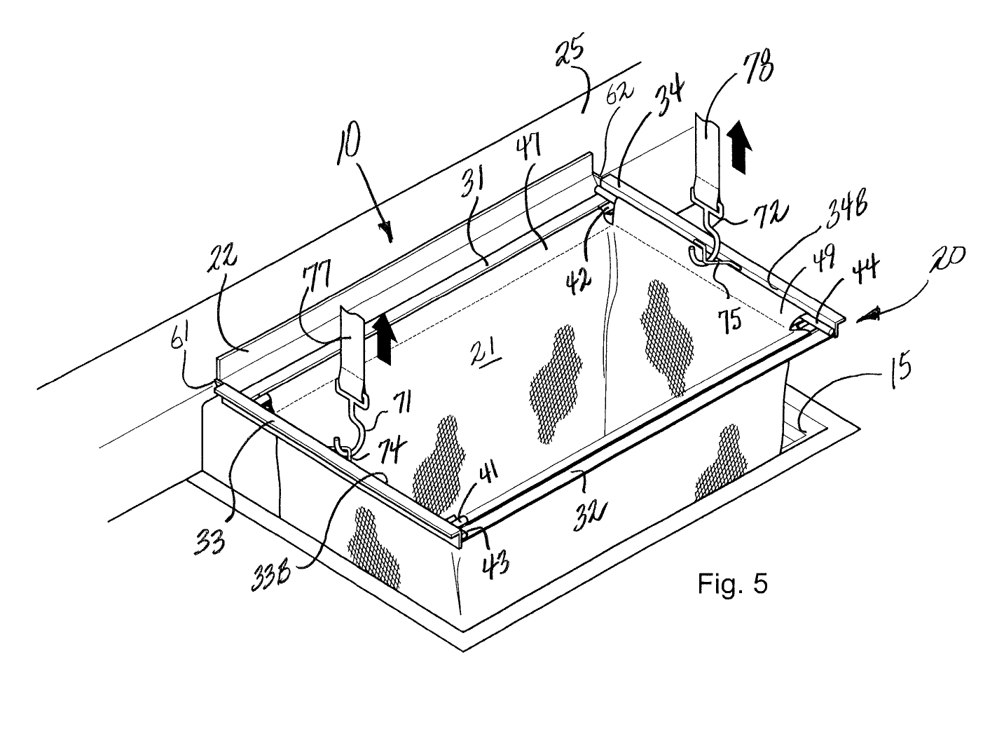

FIG. 5 illustrates the process for removing and emptying the silt bag 21. After the silt bag 21 is filled, the iron grate 14 is removed and a pair of lift hooks 71 and 72 inserted through respective lift eyes 74 and 75 attached to the side frame members 33 and 34. The lift eyes 74 and 75 are located on the inside of the vertical flanges 33B and 34B to avoid interfering with placement of the grate 14. Nylon straps 77 and 78 or metal chains are attached to the lift hooks 71 and 72 and used to remove the frame 20 and silt bag 21 simultaneously from the mouth 15 of the catch basin 12. Once removed, the silt bag 21 can be separated from the frame 20 and emptied.

A silt filtration system is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A silt filtration system adapted for placement at an inlet of a storm water catch basin, and cooperating with a grate located adjacent a street curb at a mouth of the inlet to separate silt and debris entrained in storm water entering the catch basin, said filtration system comprising:
(a) a frame adapted for residing between the grate and the mouth of the inlet, and having elongated front, rear, and opposing side frame members;
(b) a filtration medium supported within said frame and arranged to filter storm water entering said catch basin through the grate; and
(c) a backsplash attached to the rear frame member, and adapted for extending outwardly from the grate and upwardly into an open curb space between the grate and the curb, such that storm water splashing over the grate and into the curb space is deflected by said backsplash into the filtration medium within said frame.

2. A silt filtration system according to claim 1, wherein said filtration medium comprises a silt bag.

3. A silt filtration system according to claim 2, and comprising cooperating front and rear support rods extending between said opposing side frame members for suspending said silt bag from said frame.

4. A silt filtration system according to claim 3, wherein said silt bag comprises open-ended front and rear sleeves formed along a top marginal portion thereof for receiving respective front and rear support rods.

5. A silt filtration system according to claim 4, wherein said frame comprises cooperating pairs of generally V-shaped carriers adapted for holding opposing ends of respective front and rear support rods.

6. A silt filtration system according to claim 5, and comprising first and second side support rods extending between said front and rear frame members and cooperating with said front and rear support rods to suspend said silt bag from said frame.

7. A silt filtration system according to claim 1, wherein said frame members comprise angle irons.

8. A silt filtration system according to claim 1, and comprising at least one lift eye attached to said frame and adapted for receiving a lift hook used to remove said frame and filtration medium from the inlet of the catch basin.

9. A silt filtration system according to claim 1, wherein said backsplash comprises a lower splash panel attached to said rear frame member, and extending outwardly from said rear frame member at an angle greater than 90 degrees and less than 160 degrees relative to a notional plane extending through said front, rear, and side frame members.

10. A silt filtration system according to claim 9, wherein said backsplash further comprises an upper splash panel formed at an angle greater than 90 degrees and less than 160 degrees to said lower splash panel.

11. A silt filtration system according to claim 1, and comprising opposing side splash panels attached to said backsplash and respective side frame members to further deflect storm water into the filtration medium within said frame.

12. A silt filtration system adapted for placement at an inlet of a storm water catch basin, and cooperating with a grate located adjacent a street curb at a mouth of the inlet to separate silt and debris entrained in storm water entering the catch basin, said filtration system comprising:
(a) a frame adapted for residing between the grate and the mouth of the inlet, and having elongated front, rear, and opposing side frame members;
(b) a silt bag supported within said frame and arranged to filter storm water entering said catch basin through the grate;
(c) a backsplash attached to the rear frame member, and adapted for extending outwardly from the grate and upwardly into an open curb space between the grate and the curb, such that storm water splashing over the grate and into the curb space is deflected by said backsplash into the filtration medium within said frame; and
(d) first and second lift eyes attached to respective side frame members and adapted for receiving lift hooks used to remove said frame and silt bag from the inlet of the catch basin.

13. A silt filtration system according to claim 12, wherein said backsplash comprises a lower splash panel attached to said rear frame member, and extending outwardly from said rear frame member at an angle greater than 90 degrees and less than 160 degrees relative to a notional plane extending through said front, rear, and side frame members.

14. A silt filtration system according to claim 13, wherein said backsplash further comprises an upper splash panel formed at an angle greater than 90 degrees and less than 160 degrees to said lower splash panel.

15. A silt filtration system according to claim 12, and comprising opposing side splash panels attached to said backsplash and respective side frame members to further deflect storm water into the filtration medium within said frame.

16. A method of filtering silt and debris entrained in storm water entering a below-grade catch basin through a grate located at an inlet of the catch basin adjacent a street curb, said method comprising the steps of:
(a) positioning a filtration medium within a frame residing between the grate and a mouth of the inlet, the frame having elongated front, rear, and opposing side frame members; and
(b) attaching a backsplash to the rear frame member, the backsplash extending outwardly from the grate and upwardly into an open curb space between the grate and the curb, such that storm water splashing over the grate and into the curb space is deflected by the backsplash into the filtration medium within the frame.

17. A method according to claim 16, and comprising removing the frame and filtration medium from the mouth of the catch basin to empty silt and debris captured by the filtration medium.

18. A method according to claim 17, wherein the step of removing the frame and filtration medium comprising securing lift hooks to respective lift eyes attached to the frame.
